(19) United States
(12) Patent Application Publication
(10) Pub. No.: US 2009/0042569 A1
(43) Pub. Date: Feb. 12, 2009

(54) METHOD AND APPARATUS FOR SUPPORTING MOBILE IP AND PROXY MIP IN EVOLVED 3GPP SYSTEMS

(75) Inventor: Kamel M. Shaheen, King of Prussia, PA (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 12/103,873

(22) Filed: Apr. 16, 2008

Related U.S. Application Data
(60) Provisional application No. 60/913,177, filed on Apr. 20, 2007.

(51) Int. Cl. H04W 4/00; H04M 1/00; H04W 40/00

(52) U.S. Cl. 455/435.2; 455/552.1; 455/445

(57) ABSTRACT

A method for reporting mobile internet protocol (MIP) capabilities of a wireless transmit/receive unit (WTRU) includes the WTRU transmitting a first message, including network MIP capability of the WTRU, the WTRU transmitting a second message including radio MIP capability of the WTRU, and the WTRU receiving a third message including network MIP availability.

### CROSS REFERENCE TO RELATED APPLICATIONS

This application claims the benefit of provisional application No. 60/913,177 filed Apr. 20, 2007 which is incorporated by reference as if fully set forth.

### FIELD OF INVENTION

The present invention is related to wireless communication.

### BACKGROUND

A goal of the Third Generation Partnership Project (3GPP) Long Term Evolution (LTE) program is to develop new technology, new architecture and new methods for settings and configurations in wireless communication systems in order to improve spectral efficiency, reduce latency and better utilize the radio resource to bring faster user experiences and richer applications and services to users with lower costs.

Mobile Internet Protocol (MIP) is a set of extensions to the Internet Protocol (IP) standards. The purpose of MIP is to allow a user to register on a foreign network and connect to the user's home network through a combination of foreign agents and home agents.

A home agent (HA) is a function with MIP. It is responsible for routing data to mobile wireless transmit/receive units (WTRUs) attached to a foreign network.

A WTRU may support proxy mobile IP (PMIP) and/or client mobile IP (CMIP). PMIP uses a mobility access gateway (MAG) that interacts with the HA on behalf of the WTRU. The use of MIP is transparent to the WTRU.

In CMIP, the WTRU supports a MIP stack and interacts with mobility agents in both home and foreign networks. The WTRU is an active participant using CMIP.

A network compatible with 3GPP evolved architectures may support PMIP and/or CMIP. It would be desirable to have a method and apparatus for a WTRU to inform the network of its MIP capabilities.

FIG. 1 is a block diagram of a baseline architecture of a 3GPP system 100 in accordance with the prior art. The system 100 may include a WTRU 102 in direct communication with a packet data network (PDN) gateway 104. The PDN gateway may send and receive untrusted non-3GPP message to/from a 3GPP authentication, authorization and accounting (AAA) server 108 through an evolved packet data gateway (ePDG) 106. For trusted non-3GPP messages, the 3GPP AAA Server 108 and the PDN gateway 104 may communicate directly. The PDN gateway 104 may communicate directly with a policy and changing rules function (PCRF) 110 for sending and receiving operator's IP service, such as internet message service (IMS) and packet switching service (PSS), for example. The PDN gateway also may communicate directly with a serving gateway 112, that may have a direct connection to a mobility management entity (MME), 118, an evolved UMTS terrestrial radio access network (EUTRAN) 116, and a second generation/third generation serving GPRS service node (2G/3G SGSN)114. The MME 118 may also communicate directly with the 2G/3G SGSN 114, the EUTRAN 116 and an home subscriber service (HSS) 120. The HSS 120 may have direct communication with the 3GPP AAA server 108.

A WTRU may receive and transmit information elements (IEs). An Information Element is a group of information that may be included within a signalling message, such as set parameters, user identifiers and the like. For example, an existing IE in the 3GPP specification is a network capability IE. The MS_Network_Capability IE indicates general WTRU characteristics and is independent of frequency band. TABLE 1 shows a prior art network capability IE.

TABLE 1

MS network capability value [24.008]
:=<GEA1 bits>
<SM capabilities via dedicated channels:
bit>
<SM capabilities via GPRS channels:
bit>
<UCS2 support: bit>
<SS Screening Indicator: bit string(2)>
<SoLSA Capability : bit>
<Revision level indicator: bit>
<PFC feature mode: bit>
<Extended GEA bits>
< LCS VA capability: bit >
<Spare bits>;

The MS network capability IE includes 1 bit to indicate a GPRS encryption algorithm (GEA), 1 bit to indicate short messaging (SM) capabilities via dedicated channels, 1 bit to indicate SM capabilities via GPRS channels, 2 bits to indicate supplemental service (SS) screening, 1 bit to indicate Support of Localized Service Area (SoLSA) capability, 1 bit to indicate Universal Character Set 2 (UCS2) support, 1 bit to indicate revision level, one bit to indicate support for Packet Flow Control (PFC) feature mode (Base Station Subsystem (BSS) packet flow), 1 bit to indicate support for Location Services value added (LCS VA) location request notification and extended GEA bits.

Another IE typically used in the 3GPP scheme is a radio access capability IE. The MS Radio Access IE is used to provide part of the network with information concerning the radio aspects of the WTRU. Table 2 shows an existing radio access capability IE.

The MS radio access capability IE is a large IE that has multiple bits indicating support for a large number of radio technologies. In general, the IE includes 4 bits to indicate support for the access technology type, and bits that indicate support, for example, for Frequency Domain Division (FDD), Time Domain Division (TDD) and Code Division Multiple Access (CDMA) radios, among others.

TABLE 2

<MS RA capability value part := [24.008]
<Access Technology Type >
<Access capabilities : bit>
< UMTS FDD Radio Access Technology
Capability : bit >
< UMTS 3.84 Mcps TDD Radio Access
Technology Capability : bit >
< CDMA 2000 Radio Access Technology
Capability : bit >
< UMTS 1.28 Mcps TDD Radio Access
Technology Capability: bit >

Accordingly, it would be beneficial if a system and method existed that allowed a WTRU to provide mobile IP information to the network, particularly in one or more IEs.

### SUMMARY

The present invention is related to a method and apparatus for reporting Third Generation Partnership Project (3GPP) and non-3GPP mobile internet capabilities of a multimode wireless transmit/receive unit (WTRU). The multi-mode WTRU may inform a core network about its multimode mobile internet capability during an attachment procedure by transmitting an IE that includes WTRU mobile IP capability data.

Additionally, the core network may inform the WTRU of the available mobile IP capability, such as CMIP or PMIP. This may also be done with an IE that includes mobile IP capability data.

### BRIEF DESCRIPTION OF THE DRAWINGS

A more detailed understanding may be had from the following description, given by way of example and to be understood in conjunction with the accompanying drawings wherein:

FIG. 1 an overview of a 3GPP and Non-3GPP network architecture in accordance with the prior art;

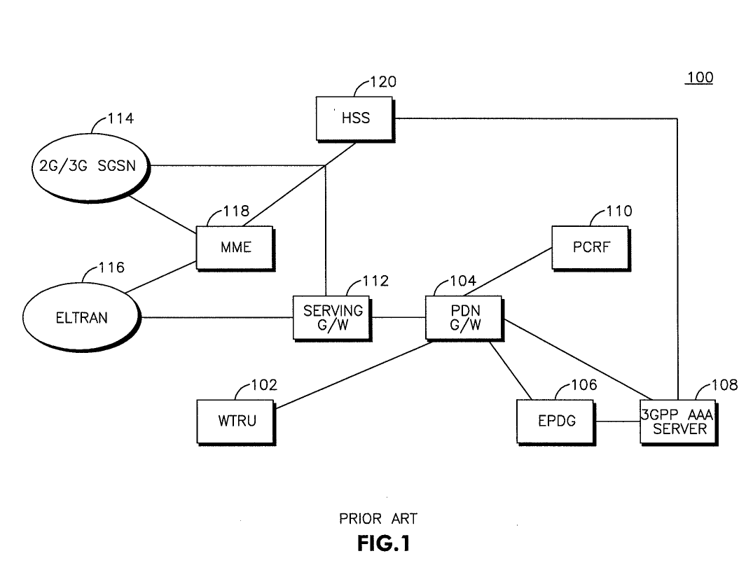

FIG. 2 shows an example of a wireless communication system in accordance with one embodiment;

FIG. 3 shows a functional block diagram of a WTRU and an Node B of FIG. 2;

FIG. 4 is a signal diagram of an attachment procedure with MIP updating in accordance with one embodiment.

### DETAILED DESCRIPTION

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B, a site controller, an access point (AP), or any other type of interfacing device capable of operating in a wireless environment.

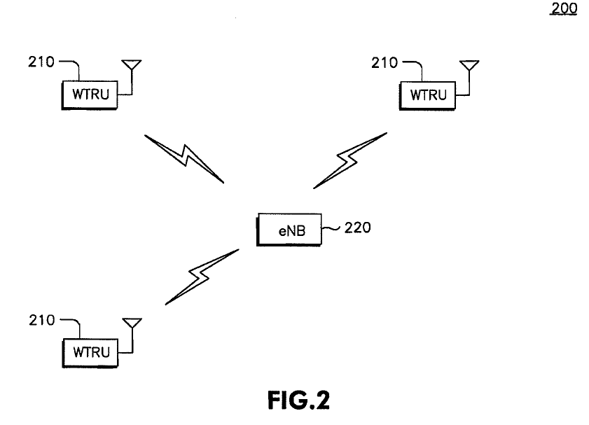

FIG. 2 shows a wireless communication system 200 including a plurality of WTRUs 210 and a e Node B 220. As shown in FIG. 2, the WTRUs 210 are in communication with the Node B 220. Although three WTRUs 210 and one Node B 220 are shown in FIG. 2, it should be noted that any combination of wireless and wired devices may be included in the wireless communication system 200.

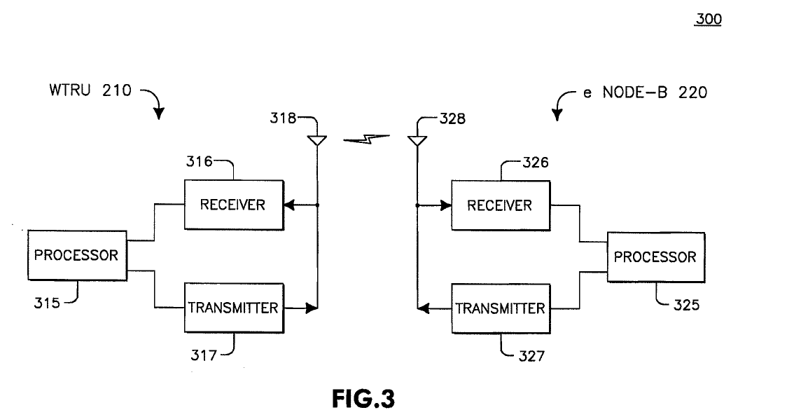

FIG. 3 is a functional block diagram 300 of the WTRU 210 and the Node B 220 of the wireless communication system 200 of FIG. 2. As shown in FIG. 2, the WTRU 210 is in communication with the Node B 220 and both are configured receive and transmit IEs as necessary.

In addition to the components that may be found in a typical WTRU, the WTRU 210 includes a processor 315, a receiver 316, a transmitter 317, and an antenna 318. The processor 315 is configured to process IEs as necessary. The receiver 316 and the transmitter 317 are in communication with the processor 315. The antenna 318 is in communication with both the receiver 316 and the transmitter 317 to facilitate the transmission and reception of wireless data.

In addition to the components that may be found in a typical Node B, the Node B 220 includes a processor 325, a receiver 326, a transmitter 327, and an antenna 328. The processor 325 is configured to process IEs as necessary. The receiver 326 and the transmitter 327 are in communication with the processor 325. The antenna 328 is in communication with both the receiver 326 and the transmitter 327 to facilitate the transmission and reception of wireless data.

WTRU MIP capability may be reported in an IE to indicate support of CMIP and/or PMIP. The IE may include, but is not limited to, technology information (e.g., Orthoganol Frequency Division Multiple Access (OFDMA), Wideband CDMA (WCDMA), and the like), supported bandwidth (e.g., 5 MHz, 10 MHz, 15 MHz, 20 MHz, and the like), bit rates, and Qualtiy of Service (QoS) support.

In a 3GPP and non-3GPP environment, the network and the WTRU may agree on the installed mobility protocol. The network may report the support of both protocols to the WTRU and the WTRU may reports its capabilities to the network. If CMIP and PMIP are both supported protocols, a preference may be indicated by the WTRU. Alternatively, if the WTRU does not indicate a preference, the network may indicate and confirm the preferred mode of operation.

If the network supports one protocol, the network may report the supported protocol to the WTRU. The WTRU may report its capabilities to support the protocol.

If the network supports the protocol reported by the WTRU the network may confirm the operation mode. Otherwise, if the network may deny service.

If the WTRU supports the protocol reported by the network, the WTRU may confirm the operation mode. Otherwise, again the network may decline service.

Table 3 below shows a network capability IE in accordance with one embodiment. The network capability IE includes an indication of support for CMIP and/or PMIP. While this may be implemented in 2 bits, one skilled in the art would realize that a fewer or greater number of bits may be utilized; depending upon how many different types of technologies must be indicted in the IE.

TABLE 3

```
  MS network capability value [24.008] :=<GEA1
  bits>
  <SM capabilities via dedicated channels: bit>
  <SM capabilities via GPRS channels: bit>
<Mobility Protocols with Non-3GPP systems:
      Client based Mobile IP
      Proxy based Mobile IP >
    <UCS2 support: bit>
    <SS Screening Indicator: bit string(2)>
    <SOLSA capability: bit>
    <Revision Level Indicator: bit>
```

Table 4 below shows a radio access capability IE in accordance with an embodiment. The radio access capability IE contains an indication of support for mobility protocols. For example, the IE may contain support for CMIP and/or PMIP.

Both the MS Network Capability Access IE and the MS Radio Capability Access IE include information that may inform the network about the multimode mobility protocol compatibilities of the WTRU. The Radio Access Capability IE carries all aspects of the EUTRAN capabilities including, but not limited to, technology information, bandwidth information, scalability, bit rates, quality of service (QoS), and may also include terminal type (PDA, Laptop, phone), memory size, screen size, and processing power.

TABLE 4

```
<MS RA capability value part := [24.008]
<Access Technology Type >
<Access capabilities : bit>
< UMTS FDD Radio Access Technology
Capability : bit >
< UMTS 3.84 Mcps TDD Radio Access
Technology Capability : bit >
<Mobility Protocols with Non-3GPP systems:
    Client based Mobile IP
    Proxy based Mobile IP >
```

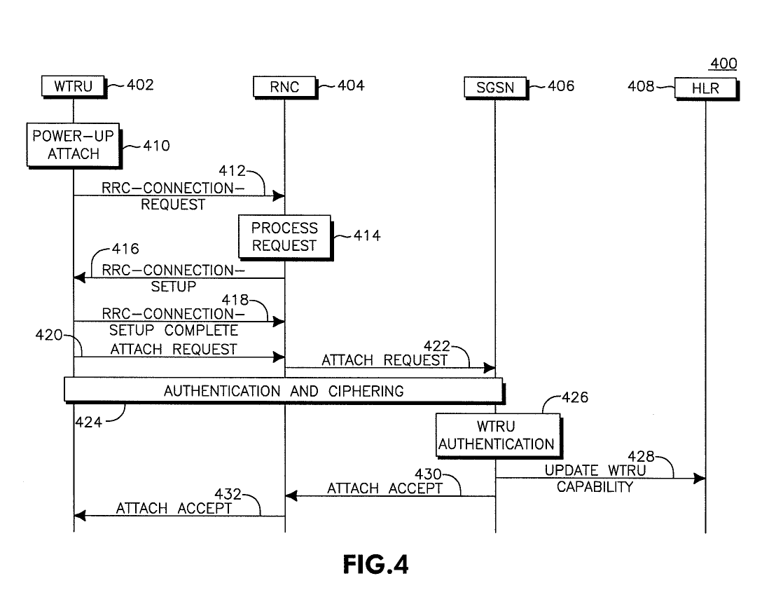

FIG. 4 is a signal diagram of an attachment procedure 400 with MIP capability updating between a WTRU 402, an RNC 404, an SGSN 406 and an HLR 408. When a WTRU 402 is powered up, it first communicates via UMTS channels. The WTRU begins a non-access stratum (NAS) “ATTACH” procedure 410 to exchange information with a core network.

The WTRU 402 transmits a message with a RRC_Connecton_Request 412 to an RNC 404. The message may also include a packet temporary mobile subscriber ID (PTMSI), a routing area ID (RAI) and a CAUSE IE. The RNC 404 processes the request, performs admission control and checks the availability of resources 414. The RNC 404 transmits a message including an RRC_CONNECTION_SETUP 416 with a UTRAN Radio Network Temporary Identifier (URTNI) to the WTRU 402. The WTRU 402 may then transmit an RRC_CONNECTION_SETUP_COMPLETE message 418 to the RNC 404, followed by an ATTACH Request 420. The ATTACH request 422 may then be forwarded by the RNC 404 to the SGSN 406. The Network_Capability IE and/or the Radio_Access_Capability IE may be included in the ATTACH request 422. The ATTACH request may also include the PTMSI and an international mobile subscriber ID (IMSI). The WTRU 402, RNC 404 and SGSN 406 perform authentication and ciphering 424, the SGSN 406 authenticates 426 the WTRU 402 and the SGSN 406 sends an update 428 to the HLR 408 containing the WTRU multimode capabilities. An Attach accept message 430 is transmitted from the SGSN 406 to the RNC 404. The RNC 404 forwards the attach accept 432 to the WTRU 402.

Although the features and elements are described in particular combinations, each feature or element can be used alone without the other features and elements or in various combinations with or without other features and elements. The methods or flow charts provided may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. A method for reporting third generation partnership project (3GPP) and non-3GPP mobile internet protocol (MIP) capabilities of a multimode capable wireless transmit/receive unit (WTRU), the method comprising:
the WTRU transmitting a first message, wherein the message comprises network MIP capability of the WTRU;
the WTRU transmitting a second message, wherein the second message comprises radio MIP capability of the WTRU; and
the WTRU receiving a third message, wherein the third message comprises MIP availability.

2. The method as in claim 1 further comprising the WTRU transmitting the first message and the second message during an ATTACH procedure.

3. The method as in claim 1 wherein the first message is a network capability information element.

4. The method as in claim 1 wherein the second message is a radio capability information element.

5. The method as in claim 3 wherein the network capability information element comprises an indication of a WTRU's multiple MIP compatibility.

6. The method as in claim 5 further comprising representing the WTRU's multiple MIP compatibility in a fixed number of bits.

7. The method as in claim 4 wherein the radio capability information element comprises an indication of a WTRU's multiple MIP compatibility.

8. The method as in claim 7 further comprising representing the radio MIP information in a fixed number of bits.

9. A method of reporting multiple operating mode capability of a wireless transmit/receive unit (WTRU), the method comprising:
transmitting a request to attach to a network; and
receiving a confirmation of attachment, wherein the request to attach to the network comprises an indication of WTRU multiple mobile internet protocol capability.

10. The method as in claim 9 further comprising the WTRU transmitting a radio resource controller (RRC) connection request signal including any of the following: Packet Temporary Mobile Subcriber Identifier (PTMSI), Routing Area Identifier (RAI) and/or CAUSE registration.

11. The method as in claim 9 further comprising the WTRU receiving an RRC connection setup signal including a UTRAN Radio Network Temporary Identifier (URNTI).

12. The method as in claim 9 wherein the indication of WTRU multiple MIP mode capability is included in a network capability information element.

13. The method as in claim 9 wherein the indication of WTRU multiple MIP mode capability is included in a radio capability information element.

14. A method of reporting mobile internet protocol (MIP) capability in a multimode wireless transmit/receive unit (WTRU), the method comprising:
the WTRU transmitting a network capability information element (IE); and
the WTRU transmitting a radio capability IE, wherein the network capability IE comprises an indication of WTRU network MIP capability and the radio capability IE comprises an indication of WTRU radio MIP capability.

15. The method as in claim 14 wherein the indication of WTRU network MIP capability comprises a fixed number of bits within the network capability IE.

16. The method as in claim 14 wherein the indication of WTRU radio MIP capability comprises a fixed number of bits within the radio capability IE.

17. The method as in claim 15 wherein the indication of WTRU network MIP capability includes an indication of network MIP capability with proxy mobile internet protocol (PMIP) or client mobile internet protocol (CMIP).

18. The method as in claim 16 wherein the indication of WTRU radio capability includes an indication of radio MIP capability with proxy mobile internet protocol (PMIP) or client mobile internet protocol (CMIP).

19. A wireless transmit/receive unit (WTRU) comprising:
a receiver configured to receive an indication of a network mobile internet protocol (MIP) availability;
a transmitter configured to transmit an indication of a WTRU MIP capability.
